(19) United States
(12) Patent Application Publication
(10) Pub. No.: US 2021/0187718 A1
(43) Pub. Date: Jun. 24, 2021

(54) Methods, Systems, and Devices for Determining a Presence of a Motor-Driven Tool Inside a Tool Position Region and/or a Tool Position of the Tool

(71) Applicant: Andreas Stihl AG & Co. KG, Waiblingen (DE)

(72) Inventor: Robert BOEKER, Waiblingen (DE)

(21) Appl. No.: 17/125,258

(22) Filed: Dec. 17, 2020

(30) Foreign Application Priority Data
Dec. 20, 2019 (EP) 19218565.0

(51) Int. Cl. B25F 5/00; G01S 3/32; G01S 3/04

(52) U.S. Cl. CPC B25F 5/00; G01S 3/043; G01S 3/325

(57) ABSTRACT

A method determines a presence of a motor-driven tool inside a tool position region and/or a tool position of the tool. A transmitter is mechanically connected to the tool, wherein the transmitter wirelessly transmits a signal. The transmitted signal is attenuated by the tool and has an item of transmitter information for taking the attenuation into account. The method has the steps of: capturing a respective reception signal strength value of the transmitted signal at receivers, wherein the receivers are arranged at different receiver positions; and determining the presence of the tool inside the tool position region and/or the tool position of the tool on the basis of the captured reception signal strength values and the received transmitter information for taking the attenuation into account.

### CROSS REFERENCE TO RELATED APPLICATION

This application claims priority under 35 U.S.C. § 119 from European Patent Application No. 19218565.0, filed Dec. 20, 2019, the entire disclosure of which is herein expressly incorporated by reference.

### BACKGROUND AND SUMMARY OF THE INVENTION

The invention relates to a method for determining a presence of a motor-driven tool inside a tool position region and/or a tool position of the tool, to a method for a method for determining a presence of a motor-driven tool inside a tool position region and/or a tool position of the tool, to a system for determining a presence of a motor-driven tool inside a tool position region and/or a tool position of the tool, to a motor-driven tool and a transmitter, and to a device for a system for determining a presence of a motor-driven tool inside a tool position region and/or a tool position of the tool.

The invention is based on the object of providing a method for determining a presence of a motor-driven tool inside a tool position region and/or a tool position of the tool, a method for a method for determining a presence of a motor-driven tool inside a tool position region and/or a tool position of the tool, a system for determining a presence of a motor-driven tool inside a tool position region and/or a tool position of the tool, a motor-driven tool and a transmitter, and a device for a system for determining a presence of a motor-driven tool inside a tool position region and/or a tool position of the tool, which each have an improved property, in particular enable a high degree of accuracy.

The invention achieves this object by providing methods, a system, a motor-driven tool and transmitter, and/or a device, in accordance with the independent claims. Advantageous developments and/or configurations of the invention are described in the dependent claims.

The method, in particular automatic method, according to the invention is designed or configured to determine or ascertain, in particular to automatically determine or ascertain, a presence of a motor-driven tool inside a tool position region and/or a tool position of the tool. A transmitter is mechanically connected, in particular directly, to the tool or the transmitter is fastened to the tool. The transmitter wirelessly transmits a signal. The transmitted signal is attenuated or at least partially shielded by the tool, in particular in a tool-type-specific manner, and comprises or has an item of transmitter information for taking the attenuation, in particular the tool-type-specific attenuation, into account. The method comprises or has the steps of: a) capturing, in particular automatically capturing, a respective reception signal strength value of the transmitted, and in particular possibly attenuated, signal at receivers. The receivers are arranged or spatially distributed at different receiver positions, in particular in a stationary manner; b) determining, in particular automatically determining, or ascertaining the presence, or in particular an absence, of the tool inside the tool position region and/or the tool position, in particular position coordinates of the tool position, of the tool on the basis of the captured reception signal strength values and the received transmitter information for taking the attenuation into account.

This makes it possible to take the attenuation into account. This therefore makes it possible to determine the presence of the tool inside the tool position region and/or the tool position of the tool with a high degree of accuracy. This can therefore enable a temporally fast and therefore efficient process with the tool, for example in a workshop, in particular during service and/or repair acceptance. This can therefore enable cost-effective and therefore customer-friendly service and/or cost-effective and therefore customer-friendly repair of the tool.

In particular, the tool may be a gardening, forestry and/or construction tool. Additionally or alternatively, the tool may be a hand-guided, in particular handheld, or a floor-guided tool. In particular, a hand-guided, in particular handheld, tool may mean that the tool may have a maximum mass of 50 kilogrammes (kg), in particular 20 kg, in particular 10 kg.

The tool position region may be an area, in particular a receiving area, for example a counter, or a wire mesh box. Alternatively or additionally, the tool position region, in particular the wire mesh box, may be composed partially or completely of at least one non-attenuating material, in particular a plastic. Further additionally or alternatively, the tool position region may be a confined tool position region.

The transmitter can be mechanically connected to the tool in the factory or in a retrofitted manner. Additionally or alternatively, the transmitter may be part of the tool, in which case the transmitter may be mechanically connected to other parts of the tool. Alternatively, the transmitter may be separate from the tool. This makes it possible to retrofit the transmitter to the tool. In particular, the tool may have, in particular only, one, in particular single, mechanical connection point which is predefined in the factory and is intended for mechanical connection for the purpose of retrofitting the transmitter. In particular, step b) can be carried out assuming that the transmitter is mechanically connected to the tool at the mechanical connection point.

The method may have the step of: transmitting, in particular automatically and/or repeatedly transmitting, the signal. Additionally or alternatively, the signal, in particular the transmitted signal, may be undirected. Further additionally or alternatively, the transmitter information may be predefined in the factory. Further additionally or alternatively, the transmitter information may be stored in a memory of the transmitter and/or of the tool. Further additionally or alternatively, the signal may have operating data relating to the tool. In this respect, reference shall also be made to the relevant technical literature.

The method may have the step of: respectively receiving, in particular automatically receiving, the transmitted signal, if not completely attenuated, by means of the receivers. In particular, step a) may comprise: capturing the respective reception signal strength value of the respectively received signal. Additionally or alternatively, the received signal may be unattenuated. Further additionally or alternatively, one of the reception signal strength values may be zero, in particular if the transmitted signal is completely attenuated.

Step b) may comprise: determining the presence of the tool inside the tool position region and/or the tool position of the tool on the basis of the captured reception signal strength values by means of lateration and/or hyperbolic position-finding. In this respect, reference shall also be made to the relevant technical literature.

Step b) can be carried out after step a) in terms of time.

The method may have the step of: outputting, in particular automatically outputting, an item of user-perceptible information relating to the presence, in particular the determined presence, of the tool inside the tool position region and/or the tool position, in particular the determined tool position, of the tool, in particular when the tool is present inside the tool position region.

In one development of the invention, the tool is a saw, a pole-pruner, a brush cutter, hedge shears, a hedge cutter, a blower, a leaf blower, branch shears, an angle grinder, a sweeper, a sweeper roller, a sweeper brush, a lawnmower, in particular a robotic lawnmower, a ride-on lawnmower or a lawnmower tractor, a scarifier, grass shears, a shredder, a stonecutter, a high-pressure cleaner or a spreading and/or spraying device.

In one development of the invention, the tool comprises or has a drive motor system, in particular for driving the tool. The transmitted signal is attenuated, in particular at least partially attenuated, by the drive motor system. In particular, the drive motor system may be an internal combustion engine drive system and/or an electric motor drive system. In particular, the transmitted signal can be attenuated by a crankcase of the internal combustion engine drive system.

In one development of the invention, the signal, in particular the transmitted signal, is a radio signal. In particular, the radio signal may have a frequency from the ISM band. In particular, the radio signal may be a Bluetooth radio signal, in particular a Bluetooth low-energy radio signal, and/or a WLAN or WiFi radio signal.

In one development of the invention, the transmitted signal is attenuated anisotropically or in a direction-dependent manner by the tool. Therefore, the reception signal strength values may differ despite possible identical spatial distances between the transmitter and the receivers.

In one development of the invention, step a) comprises or has: capturing a respective reception signal strength value of the transmitted signal at at least four receivers. The at least four receivers are arranged or spatially distributed at at least four different receiver positions, in particular in a stationary manner. This makes it possible to determine the presence of the tool inside the tool position region and/or the tool position of the tool, in particular by means of lateration and/or hyperbolic position-finding, even if one of the reception signal strength values is zero. At least three of the reception signal strength values are typically greater than zero.

In one development of the invention, the transmitter information comprises or has at least one, in particular tool-type-specific, attenuation value of the attenuation. Step b) comprises or has: determining the presence of the tool inside the tool position region and/or the tool position of the tool on the basis of the at least one received attenuation value of the attenuation. This makes it possible to take the attenuation into account. In particular, the at least one attenuation value may be an attenuation value matrix in a coordinate system of the tool. Additionally or alternatively, the at least one attenuation value may be predefined in the factory. Further additionally or alternatively, the at least one attenuation value may be stored in a memory of the transmitter and/or of the tool.

In one development of the invention, the transmitter information comprises or has an identifier, in particular a unique identifier, of the transmitter and/or of the tool. An item of attenuation information, in particular an item of tool-type-specific attenuation information, based on the attenuation, in particular at least one, in particular tool-type-specific, attenuation value of the attenuation, is assigned, in particular logically, to the identifier, in particular in a database. Step b) comprises or has: ascertaining, in particular automatically ascertaining, the attenuation information based on the attenuation on the basis of the received identifier, in particular from the database, and determining the presence of the tool inside the tool position region and/or the tool position of the tool on the basis of the ascertained attenuation information, in particular the at least one ascertained attenuation value of the attenuation. This makes it possible to take the attenuation into account. Additionally, if the tool is accepted, the identifier can be used to create or generate a service and/or repair order. This can therefore enable a temporally fast and therefore efficient process with the tool. In particular, the identifier may have, in particular be, a MAC address and/or a serial number. Additionally or alternatively, the identifier may be predefined in the factory. Further additionally or alternatively, the identifier may be stored in a memory of the tool and/or of the transmitter. Further additionally or alternatively, the attenuation information may be predefined in the factory. Further additionally or alternatively, the at least one attenuation value may be an attenuation value matrix in a coordinate system of the tool.

In one development, in particular one configuration, of the invention, the method comprises or has the step of: predefining, in particular automatically predefining, at least one, in particular the at least one and/or a tool-type-specific, attenuation value of the attenuation and the different receiver positions, in particular position coordinates of the receiver positions, of the receivers. Step b) comprises or has: calculating, in particular automatically calculating, the tool position of the tool on the basis of the captured reception signal strength values, the at least one predefined attenuation value of the attenuation and the predefined different receiver positions of the receivers, in particular by means of lateration and/or hyperbolic position-finding. This makes it possible to take the attenuation into account. In particular, the operation of predefining the at least one attenuation value may comprise transmitting or ascertaining the at least one attenuation value. Additionally or alternatively, the at least one attenuation value may be an attenuation value matrix in a coordinate system of the tool. Further additionally or alternatively, the at least one attenuation value and/or the different receiver positions may be predefined in the factory.

In one development, in particular one configuration, of the invention, the method comprises or has the step of: predefining, in particular automatically predefining, respectively, in particular logically, assigned, in particular tool-type-specific, comparison reception signal strength values for different possible tool positions, and in particular respectively different possible tool orientations, of the tool, in particular inside the tool position region. Additionally or alternatively, the transmitter information respectively comprises or has the, in particular logically, assigned comparison reception signal strength values for the different possible tool positions, and in particular the different possible tool orientations, of the tool, in particular inside the tool position region. Step b) comprises or has: comparing, in particular automatically comparing, the captured reception signal strength values with the comparison reception signal strength values, and determining the presence of the tool inside the tool position region and/or the tool position of the tool on the basis of a result of the comparison. This makes it possible to take the attenuation into account. In particular, the attenuation information may respectively have the assigned comparison reception signal strength values for the different possible tool positions, and in particular the different possible tool orientations. In other words: the operation of respectively predefining the assigned comparison reception signal strength values for the different possible tool positions, and in particular the different possible tool orientations, may comprise respectively ascertaining the assigned comparison reception signal strength values for the different possible tool positions, and in particular the different possible tool orientations. Further additionally or alternatively, the assigned comparison reception signal strength values may be respectively predefined in the factory for the different possible tool positions, and in particular the different possible tool orientations. Further additionally or alternatively, the determination may comprise selecting the comparison reception signal strength values which are closest to the captured reception signal strength values and, on the basis thereof, selecting the assigned tool position, and in particular the assigned tool orientation. Further additionally or alternatively, the assigned comparison reception signal strength values may each be measured and/or have been measured by means of calibration for the different possible tool positions, and in particular the different possible tool orientations.

In one configuration of the invention, the method comprises or has the step of: predefining, in particular automatically predefining, at least one, in particular the at least one and/or a tool-type-specific, attenuation value of the attenuation and the different receiver positions, in particular position coordinates of the receiver positions, of the receivers. The method comprises or has the step of: respectively calculating, in particular automatically calculating, the comparison reception signal strength values for the different possible tool positions, and in particular the different possible tool orientations, of the tool, in particular inside the tool position region, on the basis of the at least one predefined attenuation value of the attenuation and the predefined different receiver positions of the receivers, in particular by means of lateration and/or hyperbolic position-finding. In particular, the operation of predefining the at least one attenuation value may comprise transmitting or ascertaining the at least one attenuation value. Additionally or alternatively, the at least one attenuation value may be an attenuation value matrix in a coordinate system of the tool. Further additionally or alternatively, the at least one attenuation value and/or the different receiver positions may be predefined in the factory. Further additionally or alternatively, the different possible tool positions, and in particular the different possible tool orientations, and the calculated comparison reception signal strength values in each case may be stored and/or may have been stored in the memory of the transmitter and/or of the tool and/or of the database.

In one development of the invention, the transmitted signal is attenuated or at least partially shielded by a further tool, in particular in a tool-type-specific manner, and comprises or has the transmitter information for taking into account the attenuation, in particular the tool-type-specific attenuation, caused by the tool. A further transmitter is mechanically connected, in particular directly, to the further tool or the further transmitter is fastened to the further tool. The further transmitter wirelessly transmits a further signal. The transmitted further signal is attenuated or at least partially shielded by the further tool and the tool, in particular in each case in a tool-type-specific manner, and comprises or has a further item of transmitter information for taking into account the attenuation, in particular the tool-type-specific attenuation, caused by the further tool. The method comprises or has the step of: capturing, in particular automatically capturing, a respective further reception signal strength value of the transmitted, and in particular possibly attenuated, further signal at the receivers. Step b) comprises or has: determining, in particular automatically determining, the tool position of the tool on the basis of, in particular only, the captured reception signal strength values and the received transmitter information for taking into account the attenuation caused by the tool, and determining, in particular automatically determining, a further tool position of the further tool on the basis of, in particular only, the captured further reception signal strength values and the received further transmitter information for taking into account the attenuation caused by the further tool, in particular as described above; respectively determining, in particular automatically determining, a degree of positioning accuracy for the determined tool position of the tool and for the determined further tool position of the further tool; maintaining, for the one tool with a higher degree of positioning accuracy, the determined presence of the one tool inside the tool position region and/or the determined one tool position of the one tool; determining, in particular automatically determining and/or redetermining, for the other tool with a lower degree of positioning accuracy, the presence of the other tool inside the tool position region and/or the other tool position of the other tool taking into account the attenuation caused by the one tool at the determined one tool position, and in particular on the basis of the captured other reception signal strength values and the received other transmitter information for taking into account the attenuation caused by the other tool. This makes it possible to take into account the attenuation caused by the tools which are possibly positioned close to one another. In particular, a high/low degree of positioning accuracy can be defined by a low/high deviation of the captured reception signal strength values from comparison reception signal strength values which are closest to the captured reception signal strength values. Additionally or alternatively, the method may have the step of: determining, for the one tool with the higher degree of positioning accuracy, the presence of the one tool inside the tool position region, in particular as described above.

The method, in particular automatic method, according to the invention is designed or configured for a method, in particular the method, in particular as described above, to determine a presence, in particular the presence, of a motor-driven tool, in particular the motor-driven tool, inside a tool position region, in particular the tool position region, and/or a tool position, in particular the tool position, of the tool. A transmitter, in particular the transmitter, is mechanically connected to the tool. The transmitter wirelessly transmits a signal, in particular the signal. The transmitted signal is attenuated by the tool, and has an item, in particular the item, of transmitter information for taking into account an attenuation, in particular the attenuation. The method comprises or has the step of: providing, in particular automatically providing, of at least one item, in particular the item, of attenuation information based on the attenuation of an, in particular at least one, in particular the, attenuation value of the attenuation, wherein in particular the attenuation information is assigned, in particular logically, an identifier, in particular the identifier, of the transmitter and/or the tool, or an item of identifier information corresponding to the identifier, wherein in particular the transmitter information has the identifier or the identifier information.

Thereby, the one or more advantages as described above may be facilitated.

In particular the method need not or may not include a step, in particular the step(s), a) and/or b). In particular the step b) may include the providing. Additionally or alternatively, the providing can be carried out after step a) in terms of time, and/or before step b) in terms of time. Further additionally or alternatively, the attenuation information may be provided by means of or from a database, in particular the database. Further additionally or alternatively, the method may include the step of: transmitting, in particular automatically transmitting and/or sending, of the attenuation information, in particular the provided attenuation information, in particular by means of or from a database, in particular the database. Further additionally or alternatively, the method may include the step of: transmitting, in particular automatically transmitting and/or receiving, of the identifier or the identifier information, in particular from at least one of the receivers, and, in particular capturing and, providing the attenuation information in response to the identifier, in particular the transmitted identifier, or the identifier information, in particular the transmitted identifier information, in particular by means of or from a database, in particular the database. Further additionally or alternatively, the method may include the step of: ascertaining, in particular automatically ascertaining, or selecting the identifier information based on the, in particular transmitted, identifier, in particular by means of or in a database, in particular the database. Further additionally or alternatively, the attenuation information may include for different possible, in particular the different possible, tool positions, in particular and different possible, in particular the different possible, tool orientations, in each case assigned, in particular logically assigned, in particular the assigned, comparison reception signal strength values. Further additionally or alternatively, the attenuation information and/or the identifier and/or the identifier information may be stored in a database, in particular the database.

The, in particular electrical, system according to the invention is designed or configured to determine or ascertain, in particular to automatically determine or ascertain, a, in particular the, presence of a, in particular the, motor-driven tool inside a, in particular the, tool position region and/or a, in particular the, tool position of the tool. A, in particular the, transmitter is mechanically connected, in particular directly, to the tool or the transmitter is fastened to the tool. The transmitter wirelessly transmits a, in particular the, signal. The transmitted signal is attenuated or at least partially shielded by the tool, in particular in a tool-type-specific manner, and comprises or has an, in particular the and/or tool-type-specific, item of transmitter information for an, in particular the, operation of taking the attenuation into account. The system comprises or has, in particular the and/or electrical, receivers, a capture device, in particular an electrical capture device, and a determination device or ascertainment device, in particular an electrical determination device or ascertainment device. The receivers are each designed or configured to wirelessly receive, in particular automatically receive, the transmitted signal and to be arranged, in particular in a stationary manner, at, in particular the, different receiver positions. The capture device is designed or configured to capture, in particular automatically capture, a, in particular the, respective reception signal strength value of the transmitted, and in particular possibly attenuated, signal at the receivers. The determination device is designed or configured to determine or ascertain, in particular automatically determine or ascertain, the presence, or in particular an absence, of the tool inside the tool position region and/or the tool position, in particular position coordinates of the tool position, of the tool on the basis of the captured reception signal strength values and the received transmitter information for taking the attenuation into account.

In particular, the system may be designed to carry out a, in particular the, method as described above. Additionally or alternatively, the determination device may have a computer.

In one development of the invention, the system comprises or has the tool, and the, in particular electrical, transmitter. The transmitter is designed or configured to wirelessly transmit, in particular automatically transmit, the signal. The tool and the transmitter are designed or configured to be mechanically connected to one another or to be fastened to one another. In particular, the transmitter is mechanically connected, in particular directly, to the tool or the transmitter is fastened to the tool.

The motor-driven tool according to the invention and the transmitter according to the invention are designed or configured to be mechanically connected, in particular directly, to one another or to be fastened to one another. In particular, the transmitter is mechanically connected, in particular directly, to the tool or the transmitter is fastened to the tool. The transmitter is designed or configured to wirelessly transmit, in particular to automatically and/or continuously transmit, a, in particular the, signal. The transmitted signal is attenuated or at least partially shielded by the tool, in particular in a tool-type-specific manner, in particular if the transmitter is mechanically connected to the tool, and comprises or has an, in particular the, item of transmitter information for taking the attenuation into account. The transmitter information comprises or has, in particular the and/or tool-type-specific, at least one attenuation value of the attenuation and/or respectively assigned, in particular the respectively assigned and/or tool-type-specific, comparison reception signal strength values for different possible, in particular the different possible, tool positions, and in particular respectively different possible, in particular the different possible, tool orientations, of the tool, in particular inside a, in particular the, tool position region.

In particular, the tool and the transmitter can be used in a method as described above, in particular for determining a, in particular the, presence of the tool inside a, in particular the, tool position region and/or a, in particular the, tool position of the tool.

The device, in particular electrical device, according to the invention is designed or configured for a system, in particular the system, in particular as described above, to determine a presence, in particular the presence, of a motor-driven tool, in particular the motor-driven tool, inside a tool position region, in particular the tool position region, and/or a tool position, in particular the tool position, of the tool. A transmitter, in particular the transmitter, is mechanically connected to the tool. The transmitter wirelessly transmits a signal, in particular the signal. The transmitted signal is attenuated by the tool, and has an item, in particular the item, of transmitter information for taking into account an attenuation, in particular the attenuation. The device comprises or has a provisioning device, in particular an electrical provisioning device. The provisioning device is designed or configured for providing, in particular automatically providing, at least one item, in particular the item, of attenuation information based on the attenuation, in particular of an at least one, in particular the, attenuation value of the attenuation. In particular the attenuation information is assigned, in particular logically, an identifier, in particular the identifier, of the transmitter and/or the tool, or an item, in particular the item, of identifier information corresponding to the identifier. In particular the transmitter information has the identifier or the identifier information.

Thereby, the one or more advantages as described above may be facilitated.

In particular the system may be designed to carry out a method, in particular the method, as described above. Additionally or alternatively, the device need not or may not include the receiver and/or the capture device and/or the determination device. In particular the system or the determination device may have the device and/or the provisioning device. Further additionally or alternatively, the device or the provisioning device may have, in particular may be, a database, in particular the database. Further additionally or alternatively, the device may have a transmitting device, in particular electrical transmitting device, for transmitting, in particular automatically transmitting, of the attenuation information, in particular the provided attenuation information, in particular to the determination device. Further additionally or alternatively, the device may have a transmitting device, in particular the transmitting device and/or electrical transmitting device, for transmitting, in particular automatically transmitting, of the identifier or the identifier information, in particular from at least one of the receivers and/or the capture device.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows an exemplary system, an exemplary motor-driven tool and transmitter according to the invention, and an exemplary method according to the invention.

FIG. 2 shows the tool and the transmitter from FIG. 1 and the method from FIG. 1.

FIG. 3 shows the method from FIG. 1, an exemplary method according to the invention, in particular of the method, and an exemplary device according to the invention, in particular of the system of FIG. 1.

### DETAILED DESCRIPTION OF THE DRAWINGS

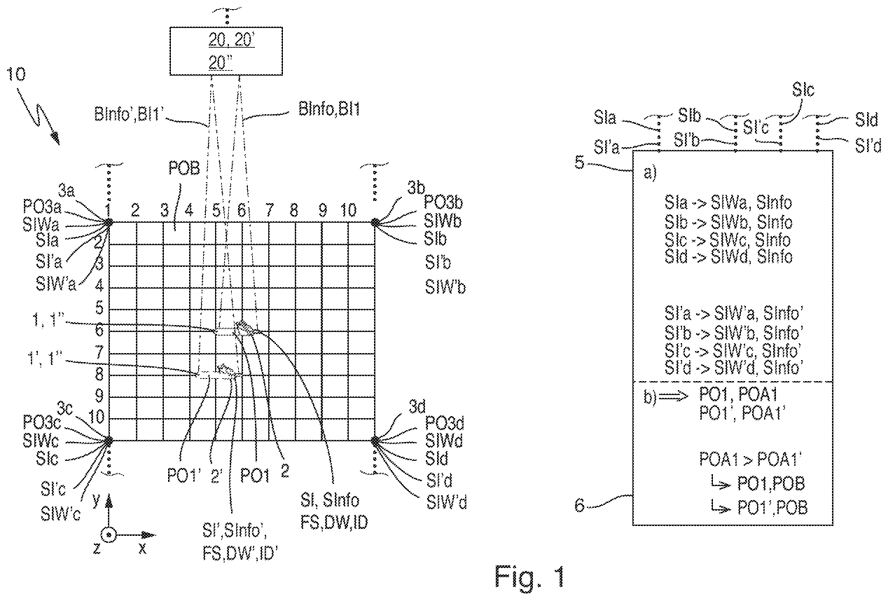

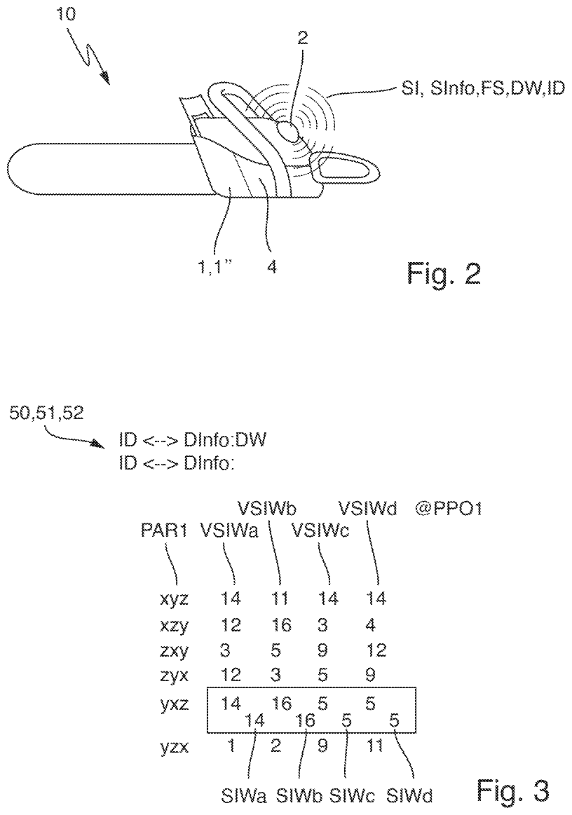

FIGS. 1 and 2 show a system 10 for determining a presence of a motor-driven tool 1 inside a tool position region POB and/or a tool position PO1 of the tool 1. A transmitter 2 is mechanically connected to the tool 1. The transmitter 2 wirelessly transmits a signal SI, in particular by means of an antenna of the transmitter 2. The transmitted signal SI is attenuated by the tool 1 and has an item of transmitter information SInfo for taking the attenuation into account. The system has receivers 3a, 3b, 3c, d, a capture device 5 and a determination device 6. The receivers 3a-d are each designed to wirelessly receive the transmitted signal SI, in particular in each case by means of an antenna of the receiver 3a-d, and to be arranged at different receiver positions PO3a, PO3b, PO3c, PO3d. The capture device 5 is designed to capture a respective reception signal strength value SIWa, SIWb, SIWc, SIWd of the transmitted signal SI at the receivers 3a-d. The determination device 6 is designed to determine the presence of the tool 1 inside the tool position region POB and/or the tool position PO1 of the tool 1 on the basis of the captured reception signal strength values SIWa-d and the received transmitter information SInfo for taking the attenuation into account.

In detail, the system 10 has the tool 1 and the transmitter 2. The transmitter 2 is designed to wirelessly transmit the signal SI. The tool 1 and the transmitter 2 are designed to be mechanically connected to one another.

FIGS. 1 to 3 show a method for determining the presence of the motor-driven tool 1 inside the tool position region POB and/or the tool position PO1 of the tool 1. The method has the steps of: a) capturing a respective reception signal strength value SIWa-d of the transmitted signal at receivers 3a-d, in particular by means of the capture device 5. The receivers 3a-d are arranged at the different receiver positions PO3a-d; b) determining the presence of the tool 1 inside the tool position region POB and/or the tool position PO1 of the tool 1 on the basis of the captured reception signal strength values SIWa-d and the received transmitter information SInfo for taking the attenuation into account, in particular by means of the determination device 6.

In detail, the method has the step of: transmitting the signal SI, in particular by means of the transmitter 2.

The method also has the step of: respectively receiving the transmitted signal SI, if not completely attenuated, by means of the receivers 3a-d.

The method also has the step of: outputting an item of user-perceptible information BInfo relating to the, in particular determined, presence of the tool 1 inside the tool position region POB and/or the, in particular determined, tool position PO1 of the tool 1, in particular by means of an output device 20 of the system 10.

In the exemplary embodiment shown, the tool position region POB is an area, in particular a two-dimensional, in particular rectangular, area and is confined.

Furthermore, in the exemplary embodiment shown, the tool 1 is a saw 1″. In alternative exemplary embodiments, the tool may be a pole pruner, a brush cutter, hedge shears, a hedge cutter, a blower, a leaf blower, branch shears, an angle grinder, a sweeper, a sweeper roller, a sweeper brush, a lawnmower, in particular a robotic lawnmower, a ride-on lawnmower or a lawnmower tractor, a scarifier, grass shears, a shredder, a stonecutter, a high-pressure cleaner or a spreading and/or spraying device.

The tool also has a drive motor system 4. The transmitted signal SI is attenuated by the drive motor system 4.

Furthermore, the, in particular transmitted, signal SI is a radio signal FS.

In addition, the transmitted signal SI is attenuated anisotropically by the tool 1.

Step a) also comprises: capturing a respective reception signal strength value SIWa-d of the transmitted signal SI at at least four receivers 3a-d. The at least four receivers 3a-d are arranged at at least four different receiver positions PO3a-d.

In the exemplary embodiment shown, the system 10 has precisely four receivers 3a-d. The four receivers 3a-d are arranged at four different receiver positions PO3a-d. In particular, the four receivers 3a-d are arranged at the four corners of the tool position region POB.

In addition, in the exemplary embodiment shown, the tool position PO1 of the tool 1 is determined in two dimensions x, y, in particular defined by a plane of the tool position region POB.

In alternative exemplary embodiments, step a) may comprise: capturing a respective reception signal strength value of the transmitted signal at more than four receivers. The more than four receivers may be arranged at more than four different receiver positions.

Additionally or alternatively, the tool position of the tool may be determined in three dimensions in alternative exemplary embodiments.

Furthermore, the transmitter information SInfo has at least one attenuation value DW of the attenuation. Step b) comprises: determining the presence of the tool 1 inside the tool position region POB and/or the tool position PO1 of the tool 1 on the basis of the at least one received attenuation value DW of the attenuation.

In addition, the transmitter information SInfo has an identifier ID of the transmitter 2 and/or of the tool 1. An item of attenuation information DInfo based on the attenuation is assigned to the identifier ID. Step b) comprises: ascertaining the attenuation information DInfo based on the attenuation on the basis of the received identifier ID, and determining the presence of the tool 1 inside the tool position region POB and/or the tool position PO1 of the tool 1 on the basis of the ascertained attenuation information DInfo.

The method also has the step of: predefining the at least one attenuation value DW of the attenuation and the different receiver positions PO3a-d of the receivers 3a-d.

Step b) comprises: calculating the tool position PO1 of the tool 1 on the basis of the captured reception signal strength values SIWa-d, the at least one predefined attenuation value DW of the attenuation and the predefined different receiver positions PO3a-d of the receivers 3a-d.

The method also has the step of: predefining respectively assigned comparison reception signal strength values VSIWa, VSIWb, VSIWc, VSIWd for different possible tool positions PPO1, and in particular different possible tool orientations PAR1, of the tool 1, in particular inside the tool position region POB. Additionally or alternatively, the transmitter information SInfo respectively has the assigned comparison reception signal strength values VSIWa-d for the different possible tool positions PPO1, and in particular the different possible tool orientations PAR1, of the tool 1, in particular inside the tool position region POB. Step b) comprises: comparing the captured reception signal strength values SIWa-d with the comparison reception signal strength values VSIWa-d, and determining the presence of the tool 1 inside the tool position region POB and/or the tool position PO1 of the tool 1 on the basis of a result of the comparison.

In the exemplary embodiment shown, the attenuation information has the at least one attenuation value DW and/or respectively has the assigned comparison reception signal strength values VSIWa-d for the different possible tool positions PPO1, and in particular the different possible tool orientations PAR1, as shown in FIG. 3.

In detail, the method has the step of: respectively calculating the comparison reception signal strength values VSIWa-d for the different possible tool positions PPO1, and in particular the different possible tool orientations PAR1, of the tool 1, in particular inside the tool position region POB, on the basis of the at least one predefined attenuation value DW of the attenuation and the predefined different receiver positions PO3a-d of the receivers 3a-d.

In the exemplary embodiment shown, the reception signal strength values SIWa-d are 14, 16, 5 and 5, as shown in FIG. 3.

Furthermore, respectively assigned comparison reception signal strength values VSIWa, VSIWb, VSIWc, VSIWd are predefined, in particular calculated, for 10×10=100 different possible tool positions PPO1, in particular tool positions arranged in the form of a grid or divided into sectors, and in particular six different possible tool orientations PAR1 in each case, equal to 600 different possibilities for the tool 1, in particular inside the tool position region POB.

In addition, the comparison reception signal strength values VSIWa-d 14, 16, 5 and 5 are closest to the captured reception signal strength values SIWa-d 14, 16, 5 and 5.

The comparison reception signal strength values VSIWa-d 14, 16, 5 and 5 are therefore selected, and on the basis thereof, the assigned tool position PPO1 is selected, in particular is determined as the tool position PO1.

Therefore, the presence of the tool 1 inside the tool position region POB and/or the tool position PO1 of the tool 1 is/are determined on the basis of the captured reception signal strength values SIWa-d and the received transmitter information SInfo for taking the attenuation into account.

In alternative exemplary embodiments, the transmitter information may have, in particular either, the at least one attenuation value or the identifier, or respectively the assigned comparison reception signal strength values for the different possible tool positions of the tool. Additionally or alternatively, in alternative exemplary embodiments, step b) may comprise: in particular either determining the presence of the tool inside the tool position region and/or the tool position of the tool on the basis of the at least one received attenuation value of the attenuation or ascertaining the attenuation information based on the attenuation on the basis of the received identifier and determining the presence of the tool inside the tool position region and/or the tool position of the tool on the basis of the ascertained attenuation information, or calculating the tool position of the tool on the basis of the captured reception signal strength values, the at least one predefined attenuation value of the attenuation and the predefined different receiver positions of the receivers, or comparing the captured reception signal strength values with the comparison reception signal strength values and determining the presence of the tool inside the tool position region and/or the tool position of the tool on the basis of a result of the comparison.

Furthermore, in the exemplary embodiment shown, the operation of outputting the user-perceptible information BInfo comprises displaying, in particular projecting and/or showing, an image BI1 of the tool 1 inside the tool position region POB and/or at the tool position PO1 of the tool 1, in particular by means of the output device 20 in the form of a display 20′, in particular a projector 20″.

This enables visual inspection.

In alternative exemplary embodiments, the image could be shown on a screen, in particular of a mobile terminal, in particular of a smartphone or a tablet, by means of augmented reality.

In detail, the image BI1 of the tool 1 is assigned to the identifier ID.

In addition, the transmitted signal SI is attenuated by a further tool 1′ and has the transmitter information SInfo for taking into account the attenuation caused by the tool 1, as shown in FIG. 1. A further transmitter 2′ is mechanically connected to the further tool 1′. The further transmitter 2′ wirelessly transmits a further signal SI′. The transmitted further signal SI′ is attenuated by the further tool 1′ and the tool 1 and has a further item of transmitter information SInfo′ for taking into account the attenuation caused by the further tool 1′. The method has the step of: capturing a respective further reception signal strength value SIW′ a, SIW′b, SIW′ c, SIW′d of the transmitted further signal SI′ at the receivers 3a-d. Step b) comprises: determining the tool position PO1 of the tool 1 on the basis of the captured reception signal strength values SIWa-d and the received transmitter information SInfo for taking into account the attenuation caused by the tool 1, and determining a further tool position PO1′ of the further tool 1′ on the basis of the captured further reception signal strength values SIW′a-d and the received further transmitter information SInfo′ for taking into account the attenuation caused by the further tool 1′, in particular as described above; respectively determining a degree of positioning accuracy POA1, POA1′ for the determined tool position PO1 of the tool 1 and for the determined further tool position PO1′ of the further tool 1′; maintaining, for the one tool 1 with a higher degree of positioning accuracy POA1, the determined presence of the one tool 1 inside the tool position region POB and/or the determined one tool position PO1 of the one tool 1; determining, for the other tool 1′ with a lower degree of positioning accuracy POA1′, the presence of the other tool 1′ inside the tool position region POB and/or the other tool position PO1′ of the other tool 1′ taking into account the attenuation caused by the one tool 1 at the determined one tool position PO1.

In the exemplary embodiment shown, the degree of positioning accuracy POA1 for the determined tool position PO1 of the tool 1 is higher than the degree of positioning accuracy POA1′ for the determined further tool position PO1′ of the further tool 1′.

Therefore, the determined presence of the tool 1 inside the tool position region POB and/or the determined tool position PO1 of the one tool 1 is/are maintained for the tool 1 with the higher degree of positioning accuracy POA1. Furthermore, the presence of the further tool 1′ inside the tool position region POB and/or the further tool position PO1′ of the further tool 1′ is/are therefore determined for the further tool 1′ with the lower degree of positioning accuracy POA1′ by taking into account the attenuation caused by the tool 1 at the determined tool position PO1.

Furthermore, FIG. 3 shows a device 50 for the system 10 to determine the presence of the motor-driven tool 1 inside the tool position region POB and/or the tool position PO1 of the tool 1. The device 50 has a provisioning device 51. The provisioning device 51 is designed for providing at least the attenuation information DInfo based on the attenuation, in particular at least of the attenuation value DW of the attenuation. In particular the attenuation information DInfo is assigned the identifier ID of the transmitter 2 and/or of the tool 1, or an item of identifier information corresponding to the identifier. In particular the transmitter information SInfo includes the identifier ID or the identifier information.

In detail, the system 10 or the determination device 6 has the device 50 and/or the provisioning device 51.

FIG. 3 shows a method for the method to determine the presence of the motor-driven tool 1 inside the tool position region POB and/or the tool position PO1 of the tool 1. The method has the step of: providing at least the attenuation information DInfo based on the attenuation, in particular at least of the attenuation value DW of the attenuation, in particular by means of the provisioning device 51 of the device 50.

In detail, the step b) includes the providing.

In the exemplary embodiment as illustrated, the device 50 has a transmitting device 52 for transmitting the attenuation information DInfo to the determination device 6 and/or the identifier ID or the identifier information from at least one of the receivers 3a-d and/or the capture device 5.

As the exemplary embodiments shown and explained above make clear, the invention provides an advantageous method for determining a presence of a motor-driven tool inside a tool position region and/or a tool position of the tool, an advantageous method for a method to determine a presence of a motor-driven tool inside a tool position region and/or a tool position of the tool, an advantageous system for determining a presence of a motor-driven tool inside a tool position region and/or a tool position of the tool, an advantageous motor-driven tool and an advantageous transmitter, and an advantageous device for a system to determine a presence of a motor-driven tool inside a tool position region and/or a tool position of the tool, which each have an improved property, in particular enable a high degree of accuracy.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for determining a presence of a motor-driven tool inside a tool position region and/or a tool position of the tool, wherein a transmitter is mechanically connected to the tool, wherein the transmitter wirelessly transmits a signal, wherein the transmitted signal is attenuated by the tool and has an item of transmitter information for taking the attenuation into account,
the method comprising the steps of:
a) capturing a respective reception signal strength value of the transmitted signal at receivers, wherein the receivers are arranged at different receiver positions; and
b) determining the presence of the tool inside the tool position region and/or the tool position of the tool on the basis of the captured reception signal strength values and the received transmitter information for taking the attenuation into account.

2. The method according to claim 1,
wherein the tool has a drive motor system, and
wherein the transmitted signal is attenuated by the drive motor system.

3. The method according to claim 1,
wherein the transmitted signal is a radio signal, and/or
wherein the transmitted signal is attenuated anisotropically by the tool.

4. The method according to claim 1,
wherein step a) comprises: capturing a respective reception signal strength value of the transmitted signal at at least four receivers, and
wherein the at least four receivers are arranged at at least four different receiver positions.

5. The method according to claim 1,
wherein the transmitter information has at least one attenuation value of the attenuation, and
wherein step b) comprises: determining the presence of the tool inside the tool position region and/or the tool position of the tool on the basis of the at least one received attenuation value of the attenuation.

6. The method according to claim 5,
wherein the transmitter information has an identifier of the transmitter and/or of the tool, wherein an item of attenuation information based on the at least one attenuation value of the attenuation, is assigned to the identifier, and
wherein step b) comprises: ascertaining the attenuation information based on the attenuation on the basis of the received identifier, and determining the presence of the tool inside the tool position region and/or the tool position of the tool on the basis of the at least one ascertained attenuation value of the attenuation.

7. The method according to claim 6,
wherein the method has the step of: predefining at least one attenuation value of the attenuation and the different receiver positions of the receivers, and
wherein step b) comprises: calculating the tool position of the tool on the basis of the captured reception signal strength values, the at least one predefined attenuation value of the attenuation and the predefined different receiver positions of the receivers.

8. The method according to claim 6,
wherein the method has the step of: predefining respectively assigned comparison reception signal strength values for different possible tool positions including different possible tool orientations, of the tool inside the tool position region, and/or wherein the transmitter information respectively has the assigned comparison reception signal strength values for the different possible tool positions including the different possible tool orientations, of the tool inside the tool position region, and
wherein step b) comprises: comparing the captured reception signal strength values with the comparison reception signal strength values, and determining the presence of the tool inside the tool position region and/or the tool position of the tool on the basis of a result of the comparison.

9. The method according to claim 8,
wherein the method has the step of: predefining at least one attenuation value of the attenuation and the different receiver positions of the receivers, and
wherein the method has the step of: respectively calculating the comparison reception signal strength values for the different possible tool positions including the different possible tool orientations, of the tool inside the position region, on the basis of the at least one predefined attenuation value of the attenuation and the predefined different receiver positions of the receivers.

10. The method according to claim 1,
wherein the transmitted signal is attenuated by a further tool and has the transmitter information for taking into account the attenuation caused by the tool, wherein a further transmitter is mechanically connected to the further tool, wherein the further transmitter wirelessly transmits a further signal, wherein the transmitted further signal is attenuated by the further tool and the tool and has a further item of transmitter information for taking into account the attenuation caused by the further tool,
wherein the method has the step of: capturing a respective further reception signal strength value of the transmitted further signal at the receivers, and
wherein step b) comprises:
determining the tool position of the tool on the basis of the captured reception signal strength values and the received transmitter information for taking into account the attenuation caused by the tool, and determining a further tool position of the further tool on the basis of the captured further reception signal strength values and the received further transmitter information for taking into account the attenuation caused by the further tool;
respectively determining a degree of positioning accuracy for the determined tool position of the tool and for the determined further tool position of the further tool;
maintaining, for the one tool with a higher degree of positioning accuracy, the determined presence of the one tool inside the tool position region and/or the determined one tool position of the one tool; and
determining, for the other tool with a lower degree of positioning accuracy, the presence of the other tool inside the tool position region and/or the other tool position of the other tool taking into account the attenuation caused by the one tool at the determined one tool position.

11. A method for a method to determine a presence of a motor-driven tool inside a tool position region and/or a tool position of the tool, wherein a transmitter is mechanically connected to the tool, wherein the transmitter wirelessly transmits a signal, wherein the transmitted signal is attenuated by the tool and has an item of transmitter information for taking the attenuation into account, according to claim 1,
wherein the method comprises the step of:
providing at least an item of attenuation information based on at least an attenuation value of the attenuation, wherein the attenuation information is assigned an identifier of the transmitter and/or the tool, or an item of identifier information corresponding to the identifier, wherein the transmitter information has the identifier or the identifier information.

12. A system for determining a presence of a motor-driven tool inside a tool position region and/or a tool position of the tool, wherein a transmitter is mechanically connected to the tool, wherein the transmitter wirelessly transmits a signal, wherein the transmitted signal is attenuated by the tool and has an item of transmitter information for taking the attenuation into account,
the system comprising:
receivers, wherein the receivers are each designed to wirelessly receive the transmitted signal and to be arranged at different receiver positions;
a capture device, wherein the capture device is designed to capture a respective reception signal strength value of the transmitted signal at the receivers; and
a determination device, wherein the determination device is designed to determine the presence of the tool inside the tool position region and/or the tool position of the tool on the basis of the captured reception signal strength values and the received transmitter information for taking the attenuation into account.

13. The system according to claim 12, further comprising:
the tool; and
the transmitter,
wherein the transmitter is designed to wirelessly transmit the signal, and
wherein the tool and the transmitter are designed to be mechanically connected to one another.

14. A motor-driven tool and transmitter, comprising:
a mechanical connection of the tool and the transmitter to one another,
wherein the transmitter is designed to wirelessly transmit a signal,
wherein the transmitted signal is attenuated by the tool and has an item of transmitter information for taking the attenuation into account, and
wherein the transmitter information has at least one attenuation value of the attenuation and/or respectively assigned comparison reception signal strength values for different possible tool positions including different possible tool orientations, of the tool inside a tool position region.

15. A device for a system to determine a presence of a motor-driven tool inside a tool position region and/or a tool position of the tool, wherein a transmitter is mechanically connected to the tool, wherein the transmitter wirelessly transmits a signal, wherein the transmitted signal is attenuated by the tool and has an item of transmitter information for taking the attenuation into account, according to claim 12,
the device comprising:
a provisioning device,
wherein the provisioning device is designed for providing at least an attenuation information based on the attenuation,
wherein the attenuation information is assigned an identifier of the transmitter and/or the tool or an item of identifier information corresponding to the identifier, and
wherein the transmitter information has the identifier or the identifier information.
